(19) United States
(12) Patent Application Publication
(10) Pub. No.: US 2019/0082675 A1
(43) Pub. Date: Mar. 21, 2019

(54) TREESTAND

(71) Applicant: Dragon Outdoor Products, Inc., Belgrade Lakes, ME (US)

(72) Inventors: Christopher W. Bradley, Belgrade, ME (US); Margaret B. Bradley, Belgrade, ME (US)

(21) Appl. No.: 15/711,113

(22) Filed: Sep. 21, 2017

(51) Int. Cl. A01M 31/02

(52) U.S. Cl. CPC A01M 31/02

(57) ABSTRACT

The present invention is for treestands for wildlife observation that reduce noise generation when used and are lighter thereby easing transport and installation.

### BACKGROUND

The present invention relates to treestands. People, especially hunters, wish to be able to observe and monitor wildlife without interfering in the wildlife's behavior. For hunters this means allowing the wildlife, i.e., game animals, to venture close enough to the hunter so that the hunter can target the animal without the animal detecting the hunter and leaving the area. For others, for example photographers or bird watchers, this means remaining hidden so that the wildlife behaves in its natural manner.

Treestands are used by people to remain relatively unnoticed by wildlife. Treestands are used to position a person above the ground and out of an animal's line of sight and smell. However, many of the treestands available today can thwart the goals of the hunter or wildlife observer. They tend to be heavy, making them both difficult to transport and install in a tree. Further, when used, they can contribute to the user being detected by an animal by contributing to an unacceptably high noise level. This noise level is caused, in part at least, by the treestand standing platform being composed substantially of metal.

What is needed in the art are treestands that are easier to transport and that do not cause unnecessary noise when used.

### SUMMARY OF THE INVENTION

The present invention provides treestands that solve the problems associated with prior art treestands in that they are lighter and in that they minimize the generation of noise when used. The treestands of the present invention are novel and non-obvious over the prior art.

In one aspect, the treestands of the present invention comprise a standing platform. The standing platform of the treestand of the present invention comprises a support platform for supporting a user, the support platform comprising a resilient and flexible material (e.g., a fabric) that is under tension. The tension can be provided by any means but in a preferred embodiment, the tension is provided by cables or cords (collectively referred to herein as “cord material”) that are laced through the edge of the resilient and flexible material, around a frame, and drawn tight. The tension on the resilient and flexible material is high enough that the fabric provides a firm platform for standing on. The resilient and flexible material may be removably attached to the frame.

In this regard, the standing platform of the treestand of the present invention comprises a support platform for supporting a user and a means for attaching the standing platform to a tree. The standing platform comprises a frame, the frame being comprised of, for example, a light weight material such as one or more of aluminum, carbon fiber, titanium or wood. The frame can be of any suitable shape. In one aspect of the invention, the frame is essentially rectangular shaped with rounded corners. When rectangular, the frame is comprised of a front frame member, a rear frame member and a first and second side frame members, collectively referred to herein as frame members. The frame may also be considered rectangular with one or more of the front, rear or side frame members bowed or curved in the plane of the standing platform. In one embodiment, the standing platform specifically excludes non-flexible members positioned between and/or attached to the frame members in the plane of the frame and between the frame members.

The support platform may comprise the resilient and flexible material of the present invention, which may be suspended between the frame members of the standing platform with a plurality of attachment points. In one embodiment, the attachment points comprise one or more cords laced through the edge of the resilient and flexible material and around the frame members, the cord material being passed alternately from the frame members and the flexible material at the attachment points. In another embodiment, the resilient and flexible material is attached by loop and hook fastener. In another embodiment, the resilient and flexible material may be extended over the frame members thereby providing for opposite ends of the flexible and resilient material to be opposingly oriented to each other under the plane of the support platform. In this aspect of the invention, the resilient and flexible material is laced with one or more cords through the edge of the resilient and flexible material under the plane of the standing platform. The cord may be threaded through grommets on the resilient and flexible material.

In some embodiments, the resilient and flexible material of the support platform may comprise areas of reduced flexibility (but still flexible), such as flexible stiffening members, overlapping layers of fabric or areas of thicker fabric. In one embodiment, the support platform specifically excludes non-flexible members. In another embodiment, support platform specifically excludes non-flexible members that attach to or touch at least one frame member. In the context of the present invention, any grommets and area of reduced flexibility used with the resilient and flexible material do not constitute non-flexible support platform members.

In one embodiment, the standing platform and the support platform of the present invention collectively can support a user weighing up to 200 lbs., 250 lbs., 300 lbs. or 350 lbs.

In one embodiment of the present invention, the support platform may further comprise a reversibly removable cover for the standing platform that covers or substantially covers the frame, the resilient and flexible material and the cord(s). The cover may be used, for example, to keep the frame and resilient and flexible material clean and/or to provide camouflaging. The cover may be padded or unpadded. The cover may be washable.

The treestand of the present invention may also comprise a seating platform located above the standing platform. The seating platform may be constructed in the same manner as the standing platform, if desired, with a seat and, optionally, back support, one or both made of resilient and flexible material placed under tension. This design will provide for a further reduction in weight and provide for a quieter treestand. However, since the user will not be standing or stepping on the seating platform, the need for noise reduction is not as great as with the standing platform. In another embodiment, the seating platform may be a comfortable hanging seat.

The treestand of the present invention further comprises a means for attaching the treestand to a tree. The present invention is not limited by the means used for attaching the treestand to a tree. Many such methods and devices are known to one of ordinary skill in the art and are incorporated herein. For example, such means include, but are not limited to, one or more of clamps, straps and spikes (e.g., points or barbs) and one or more suitable tensioning devices such as ratchets and turnbuckles, as are known in the art. The treestand of the present invention may have one attachment device or a separate attachment device for each of the standing platform and seating platform. Further, stabilizers such as spikes may be used to stabilize the platform to the tree.

In yet another aspect of the treestand of the present invention, the treestand may be collapsible or foldable for ease of transport or storage. In yet another aspect of the present invention, the seating platform may be attached to, reversibly removable from or separate from the standing platform.

### DESCRIPTION OF THE FIGURES

FIG. 1 shows a perspective view of a first embodiment of the invention.

FIG. 2 shows a perspective view of a second embodiment of the invention

FIG. 3 shows a side view of the invention of FIG. 1.

FIG. 4 shows a side view of the invention of FIG. 2.

FIG. 5 shows a bottom view of the standing platform of the invention of FIG. 1.

FIG. 6 shows a bottom view of the standing platform of the invention of FIG. 2

FIG. 7 shows a top view of the standing platform of the invention of FIG. 1.

FIG. 8 shows a top view of the standing platform of the invention of FIG. 2.

FIG. 9 shows the standing platform with a reversibly removable cover removed from the standing platform

FIG. 10 shows the reversibly removable cover on the standing platform.

### DETAILED DESCRIPTION OF THE INVENTION

The invention will now be described in further detail and as exemplified by the figures.

Various embodiments of the invention will now be explained in greater detail. It is to be understood that both the foregoing general description and the following detailed description are exemplary and explanatory only, and are not restrictive of the invention as claimed. Any discussion of certain embodiments or features serves to illustrate certain exemplary aspects of the invention. The invention is not limited to the embodiments specifically discussed herein.

Unless otherwise indicated, all numbers such as those expressing temperatures, weight percent, concentrations, time periods, dimensions, and values for certain parameters used in the specification and claims are to be understood as being modified in all instances by the term “about,” unless clearly stated otherwise. It should also be understood that the precise numerical values and ranges used in the specification and claims form additional embodiments of the invention.

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. Instead, the proper scope of the embodiments is defined by the appended claims. Further, stating that a feature may exist indicates that the feature may exist in one or more embodiments.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value and all values between, regardless as to if they have been explicitly identified. Similarly, when values are expressed as approximations, by use of the antecedent “about,” it will be understood that the particular value forms another embodiment.

In this disclosure, the terms “include,” “including,” “comprise,” “comprising,” “contain,” “containing,” “have,” and “having” when used after a device, set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or. Moreover, if these terms are used, a subset of a set may include one or more than one, up to and including all members of the set.

The phrase “consisting of” excludes any element, step or ingredient not specified in the claim. The phrase “consisting essentially of” limits the scope of a claim to the specified materials or steps and materials or steps that do not materially affect the basic and novel characteristics of the claimed invention. It is clear from this specification which elements do and do not materially affect the basic and novel characteristics of the claimed invention. Further, any elements recited in a dependent claim, even though further limiting, are not considered to be essential to the elements recited in the identified independent claim. The present disclosure contemplates embodiments of the invention compositions and methods corresponding to the scope of each of these phrases. Thus, a composition or method comprising recited elements or steps contemplates particular embodiments in which the composition or method consists essentially of or consists of those elements or steps.

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods and materials are now described.

The present invention is for treestands for wildlife observation that reduce noise generation when used and are lighter thereby easing transport and installation, as is evident from the description.

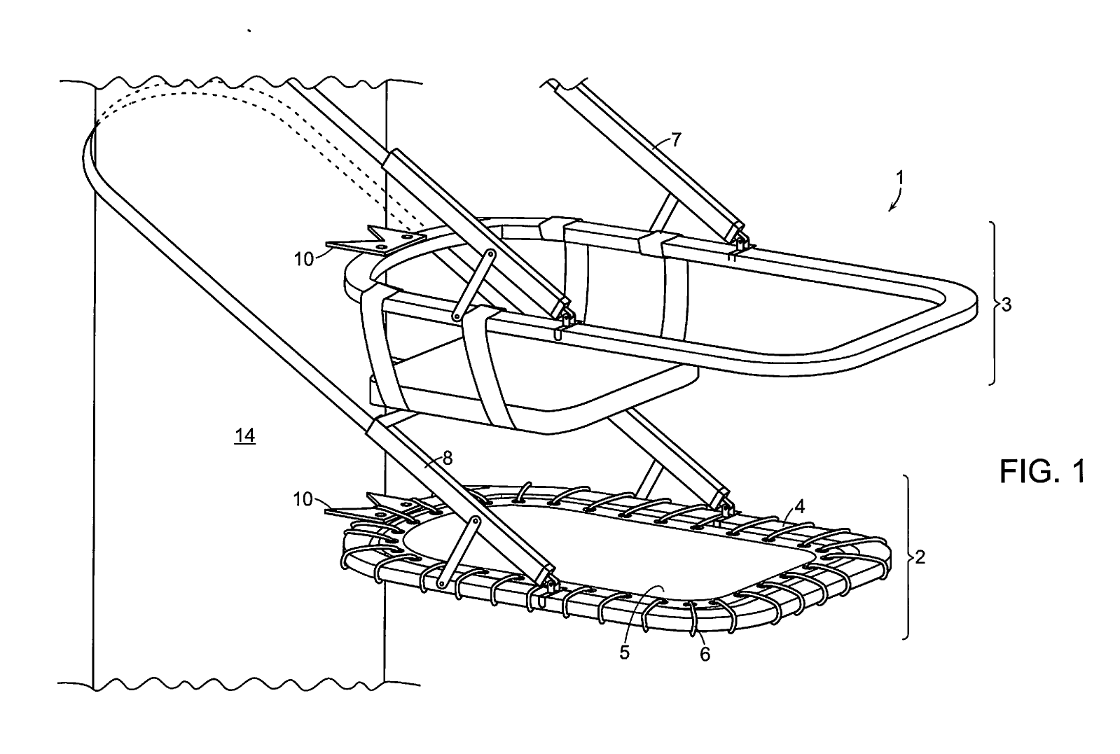

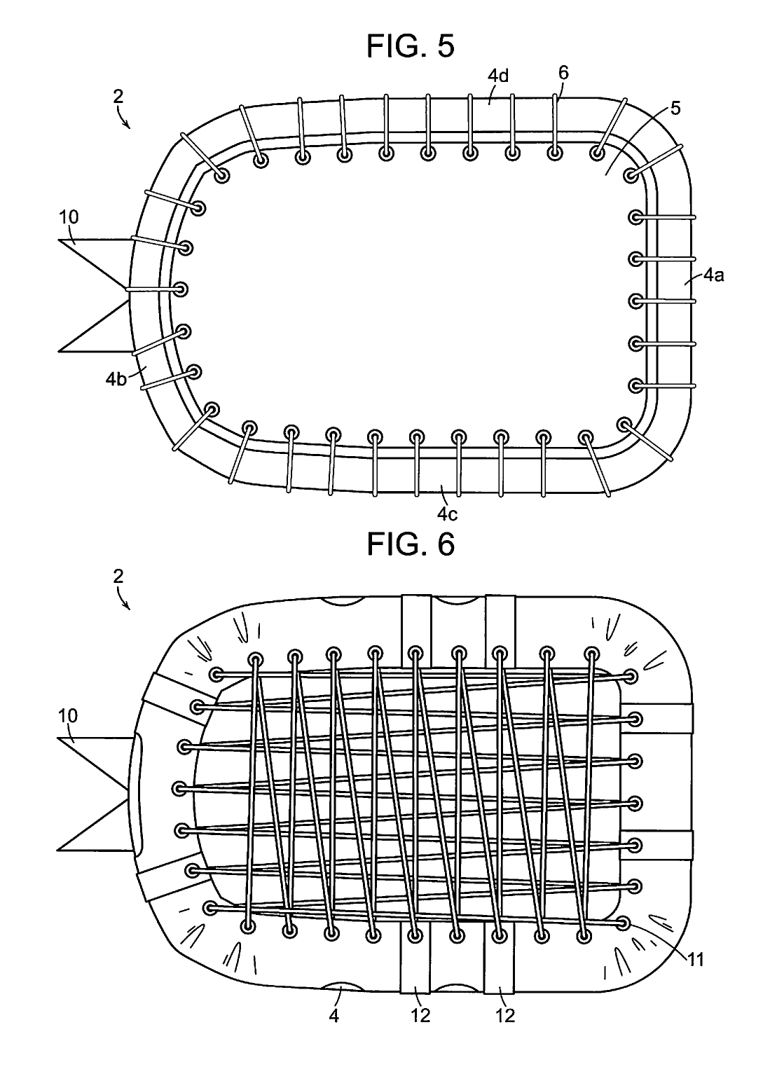

FIG. 1 shows a perspective view of a first embodiment of the treestand of the present invention mounted on a tree. The treestand 1 comprises a standing platform 2 and a seating platform 3. The support platform on the standing platform comprises the frame 4, the resilient and flexible material 5 and cord 6. The frame may comprise a front frame member, a rear frame member and a first and a second side member, as clearly shown and detailed in FIGS. 5 & 7. The treestand shown also comprises an upper anchoring device 7 and a lower anchoring device 8, as well as stabilizers 10 for anchoring the stand to a tree 14. Stabilizers may comprise one or more of spikes, points, teeth, a course or rough material (similar to course sand paper or antiskid flooring surfacing), or a dense foam material. In a preferred embodiment, the stabilizer will have several points that will be in contact with the tree trunk to keep the treestand from shifting or moving horizontally.

“Resilient and flexible material” is described herein as fabric material that is able to recoil or spring back into shape after bending, stretching, or being compressed and capable of bending easily without breaking. Exemplary examples of fabric suitable for use in the present invention include, but are not limited to polypropylene fabrics including polypropylene mesh. The resilient and flexible material may be woven or non-woven. The resilient and flexible material may have a grab tensile strength of about 450 MPa-550 MPa or about 495 MPa for MD (machine direction) and about 400 MPa-475 MPa or about 435 MPa for CD (cross direction), as measured by ASTM standards such as ASTM D 5034-95. Other materials may also be suitable for use in the present invention and a person of skill in the art, in view of the teachings of this specification, will be able to identify such resilient and flexible fabrics without undue experimentation.

The cord, cords or cording used with the present invention is also resilient and flexible. Exemplary examples of cord suitable for use with the present invention include, but are not limited to nylon cord. The cord of the present invention may have a tensile strength of about 200 to about 800 lbs. or about 300 to about 500 lbs. The cord of the present invention may be under a tension suitable to support a person of up to 350 lbs. when installed on the treestand of the present invention. Other materials may also be suitable for use in the present invention and a person of skill in the art, in view of the teachings of this specification, will be able to identify such resilient and flexible fabrics without undue experimentation.

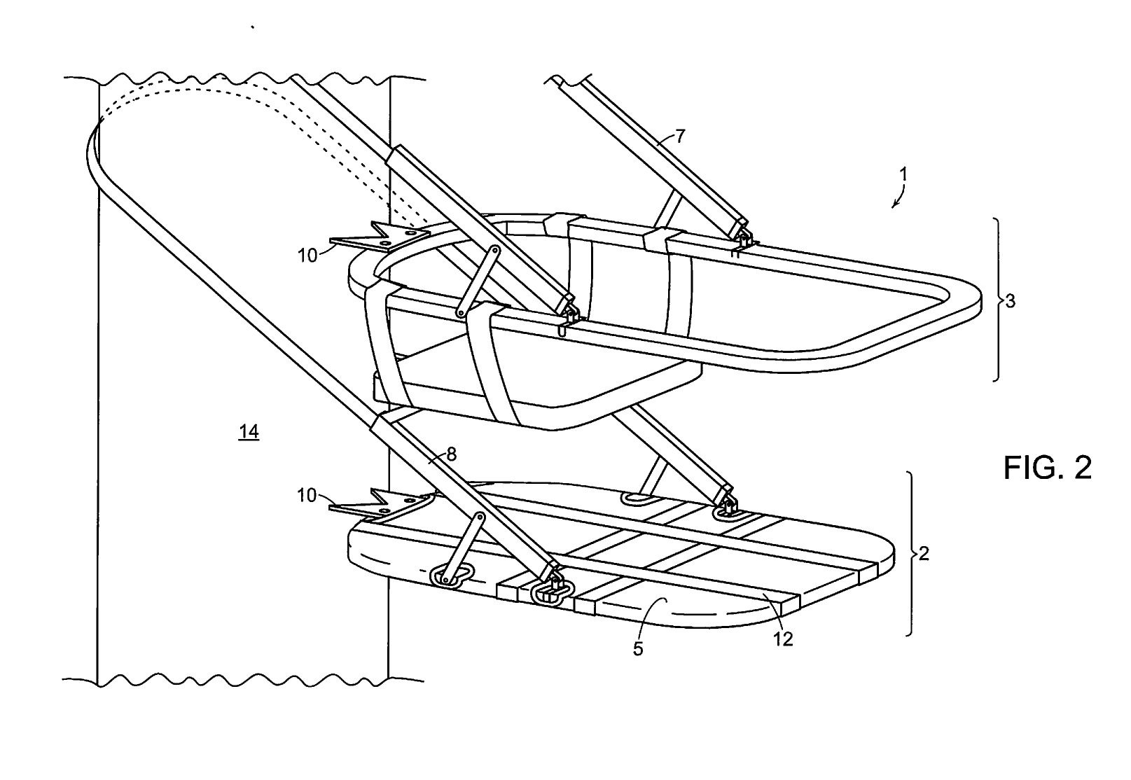

FIG. 2 shows a perspective view of a second embodiment of the treestand of the present invention mounted on a tree. The treestand 1 comprises a standing platform 2 and a seating platform 3. The support platform on the standing platform comprises the frame covered with a resilient and flexible material 5 and, in some embodiments, reinforcement straps 12 separate from or integral with the resilient and flexible material. The frame may comprise a front frame member, a rear frame member and a first and a second side member supporting and covered by the fabric. The treestand shown also comprises an upper anchoring device 7 and a lower anchoring device 8, as well as a stabilizing device such as stabilizing spikes 10 for attaching the stand to a tree 14

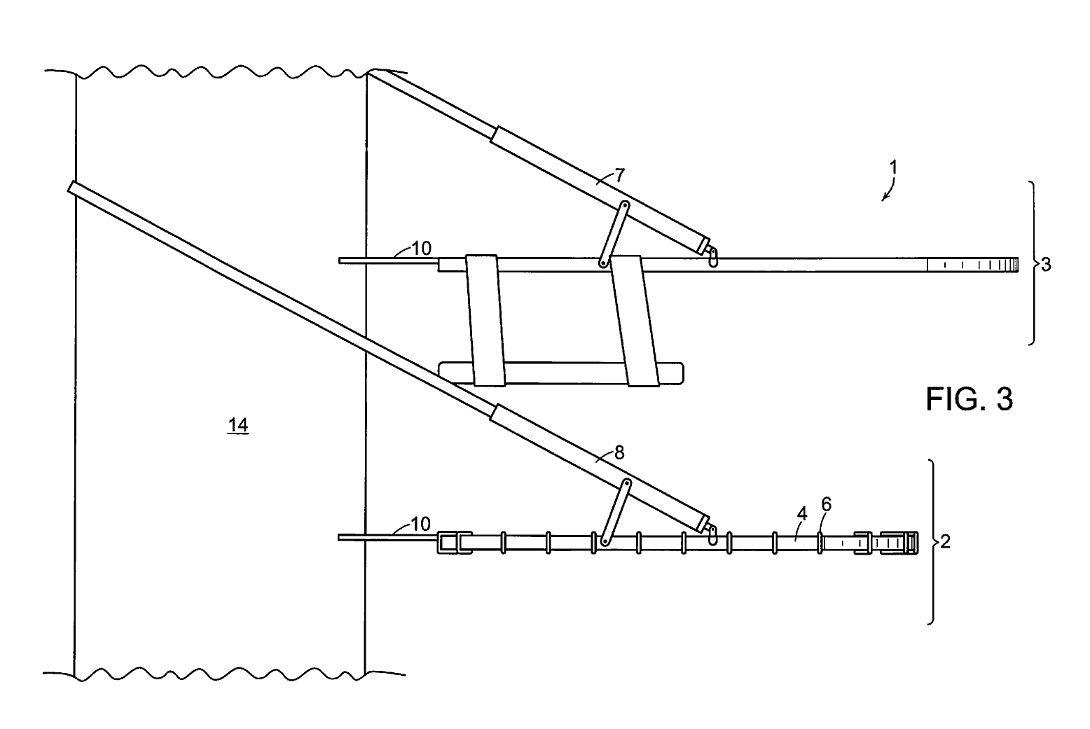

FIG. 3 shows a side view of the first embodiment of the treestand of the present invention. As with FIG. 1, the treestand 1 comprises a standing platform 2 and a seating platform 3. The support platform on the standing platform comprises the frame 4, the resilient and flexible material (not visible) and cord 6. A side frame member of the frame 4 is shown. The treestand shown also comprises an upper anchoring device 7 and a lower anchoring device 8, as well as stabilizing spikes 10.

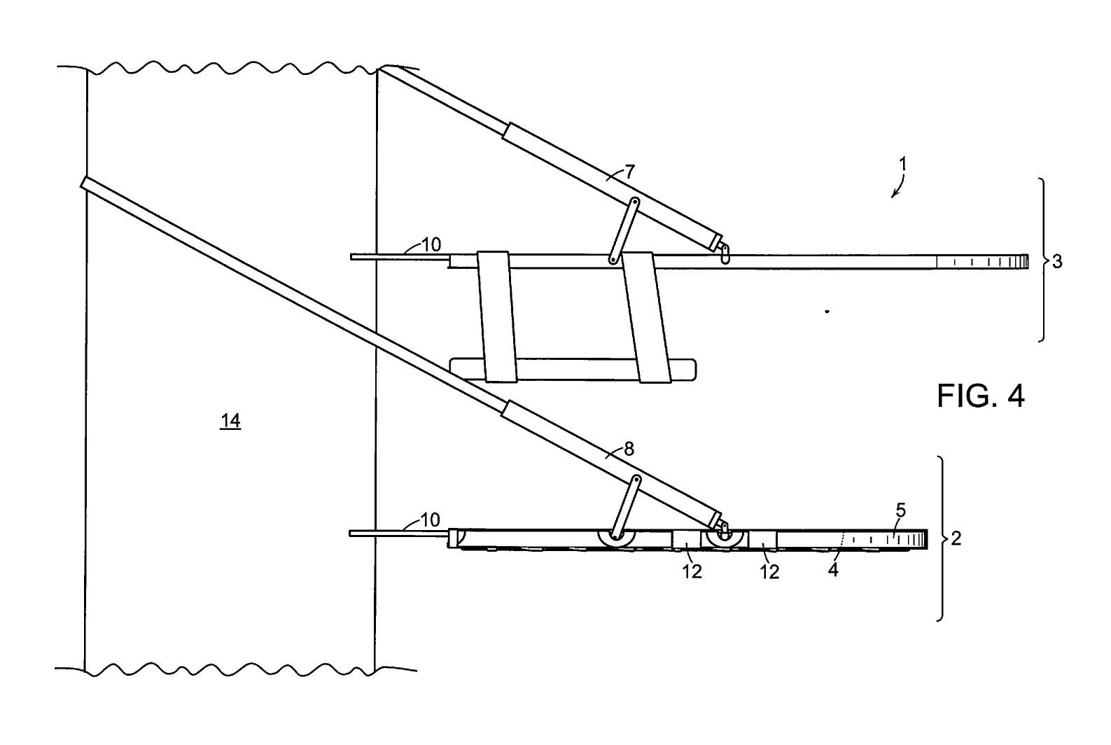

FIG. 4 shows a side view of the second embodiment of the treestand of the present invention. In this embodiment, the resilient and flexible material 5 covers the frame except where it is necessary to expose the frame 4 to attach, for example the lower anchoring device 8 and a stabilizing device such as stabilizing spikes 10.

FIG. 5 shows a bottom view of the standing platform of the first embodiment of the treestand of the present invention. The frame 4 with a front frame member 4a, rear frame member 4b, and first 4c and second side member 4d are shown. The resilient and flexible material 5 is shown extending between the frame members and secured with cord 6. Grommets 11 may be used to provide strength to the resilient and flexible fabric where the cord passes through. Further, a cord or other stiffening material may be used to provide strength at the edge of the resilient and flexible material by being secured to or surrounded by the edge of the resilient and flexible material by, for example, sewing, gluing, melting or other means known to one of ordinary skill in the art. In the context of the present invention, any grommets and stiffening material used on the resilient and flexible material do not constitute non-flexible members. A stabilizing device comprising spikes 10 is also shown.

FIG. 6 shows a bottom view of the standing platform of the second embodiment of the treestand of the present invention. The resilient and flexible material is wrapped around the frame 4. Areas of stiffer but still flexible material added for increase strength are shown 12. The Resilient and flexible material is secured with cord 6 laced through grommets 11 in the resilient and flexible material. A stabilizing device comprising spikes 10 is also shown.

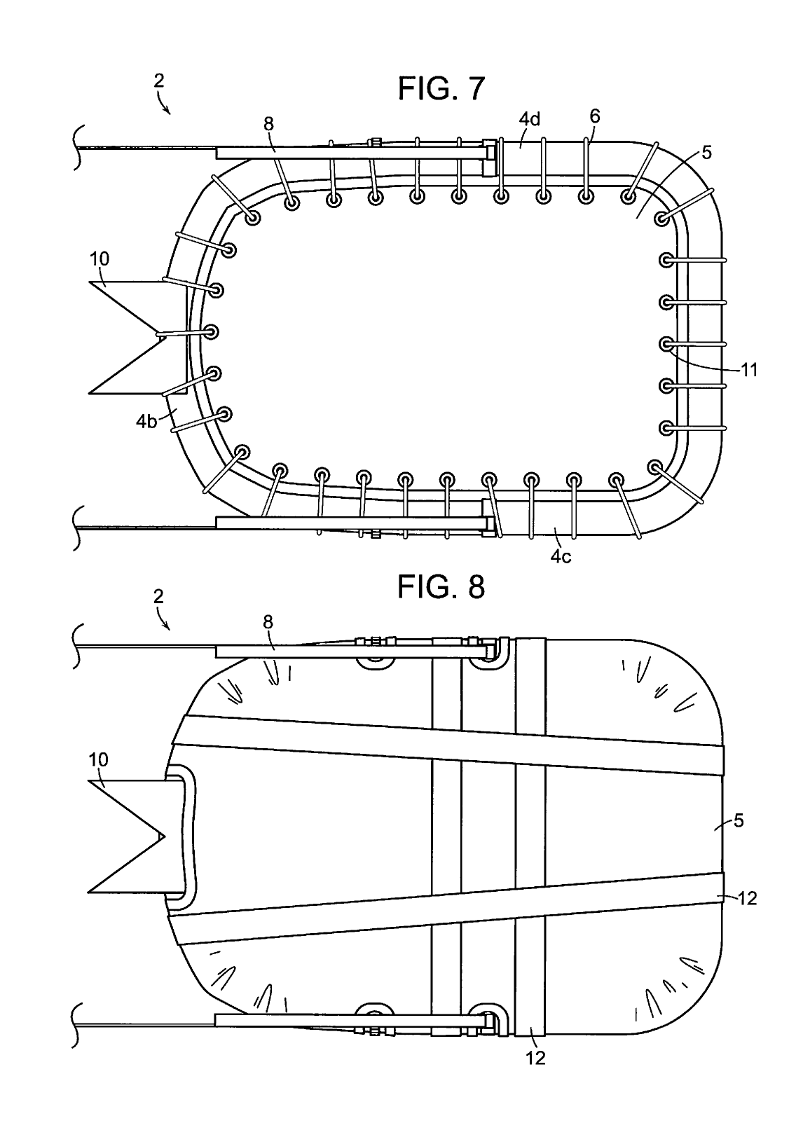

FIG. 7 shows a top view of the standing platform of the first embodiment of the treestand of the present invention. The frame 4 with a front frame member, rear frame member 4b, and first 4c and second side member 4d are shown. The resilient and flexible material 5 is shown extending between the frame members and secured with cord 6. Grommets 11 may be used to provide strength to the resilient and flexible fabric where the cord passes through. Further, a cord or other stiffening material may be used to provide strength at the edge of the resilient and flexible material by being secured to or surrounded by the edge of the resilient and flexible material by, for example, sewing, gluing, melting or other means known to one of ordinary skill in the art. In the context of the present invention, any grommets and stiffening material used on the resilient and flexible material do not constitute non-flexible members. A stabilizing device comprising spikes 10 and lower anchoring device 8 are also shown.

FIG. 8 shows a top view of the standing platform of the second embodiment of the treestand of the present invention. The resilient and flexible material 5 is wrapped around the frame (not clearly visible). Areas of stiffer but still flexible material added for increase strength are shown 12. The stabilizing spikes 10 and lower anchoring device 8 are also shown.

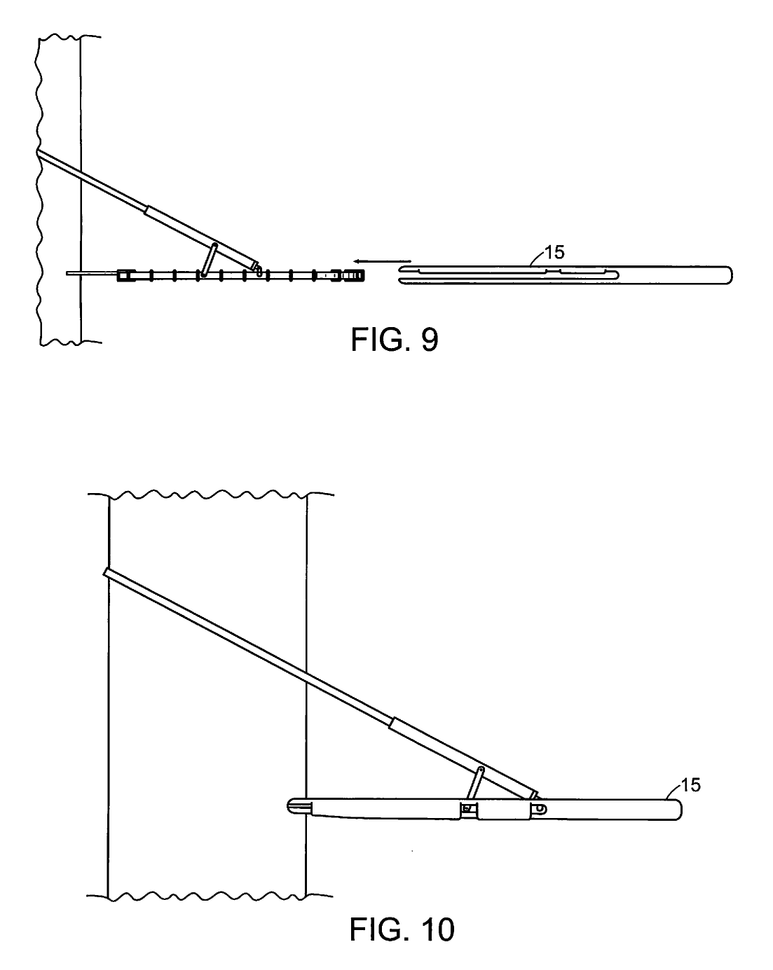

FIG. 9 shows the standing platform covered with a reversibly removable cover 15 being placed on the standing platform. FIG. 10 shows the reversibly removable cover 15 placed on the standing platform. The cover may be made of any suitable fabric.

We claim:

1. A treestand, comprising:
a. a standing platform adapted to be secured to a tree, the standing platform including: (i) a frame having a front frame member, rear frame member and first and second side frame members; and (ii) a support platform to provide a user with a platform to stand on, the support platform connected to and extending between the front frame member, the rear frame member and the first and second side frame-members, the support platform comprising: a flexible and resilient material suspended between and not touching said frame members and removably attached to said frame members with a plurality of attachment points, wherein the support platform specifically excludes non-flexible support members and said support platform is under tension;
b. a seating platform positioned above the standing platform comprising a frame adapted to be secured to the tree at a position above the standing platform and to provide a user with a seat.

2. The treestand of claim 1, wherein said removably attached flexible and resilient material is attached to said standing platform frame members by a cord material, said cord material being passed alternately from the standing platform frame members and the flexible material at said attachment points.

3. (canceled)

4. (canceled)

5. The treestand of claim 1, wherein said support platform supports a user up to 350 lbs.

6. The treestand of claim 1, further comprising a reversibly removable cover over said frame and support platform.

7. The treestand of claim 1, wherein said frame of said standing platform is made of one or more of aluminum, carbon fiber and titanium.

8. The treestand of claim 1, wherein said seating portion frame comprises frame members made of one or more of aluminum, carbon fiber and titanium.

9. The treestand of claim 1, wherein said attachment points of said flexible and resilient material of said support platform comprise grommets.

10. The treestand of claim 1, wherein said standing platform and seating platform are secured to the tree by one or more attachment devices wrapped around the tree.

11. A treestand, comprising:
a. a standing platform adapted to be secured to a tree, the standing platform including: (i) a frame having a front frame member, rear frame member and first and second side frame members; and (ii) a support platform to provide a user with a platform to stand on, the support platform connected to and extending over the front frame member, the rear frame member and the first and second side frame-members, the support platform comprising: a flexible and resilient material extending around the outer edge of said frame members and extending under the frame of the standing platform thereby providing for opposite edges of the flexible and resilient material to be opposingly oriented to each other under the frame of the standing platform and attached to each other at a plurality of attachment points, wherein the support platform specifically excludes non-flexible support members and wherein said support platform is under tension;
b. a seating platform comprising a frame adapted to be secured to the tree at a position above the standing platform and to provide a user with a seat.

12. The treestand of claim 11, wherein said support platform comprising removably attached flexible and resilient material is attached by a flexible cord material, said cord material being passed alternately between opposingly oriented ends of the flexible material at said attachment points.

13. (canceled)

14. (canceled)

15. The treestand of claim 11, wherein said support platform supports a user up to 350 lbs.

16. The treestand of claim 11, further comprising a reversibly removable cover over said support platform.

17. The treestand of claim 11, wherein said frame of said standing platform is made of one or more of aluminum, carbon fiber and titanium.

18. The treestand of claim 11, wherein said seating portion frame comprises frame members made of one or more of aluminum, carbon fiber and titanium.

19. The treestand of claim 11, wherein said attachment points of said flexible and resilient material of said support platform comprise grommets.

20. The treestand of claim 11, wherein said standing platform and seating platform are secured to the tree by one or more attachment devices wrapped around the tree.
